(19) United States
(12) Patent Application Publication
(10) Pub. No.: US 2016/0043610 A1
(43) Pub. Date: Feb. 11, 2016

(54) CLEAN LOCOMOTIVE POWER GENERATION SYSTEM

(71) Applicant: CURTIS C. KING, Texarkana, TX (US)

(72) Inventor: CURTIS C. KING, Texarkana, TX (US)

(21) Appl. No.: 14/453,731

(22) Filed: Aug. 7, 2014

(51) Int. Cl. H02K 7/18

(52) U.S. Cl. CPC H02K 7/1846

(57) ABSTRACT

The present application relates to a clean power generation and distribution system for a train. The system comprises a charging car and a storage car mechanically and electrically coupled together. Power is generated from the charging car as a result of the movement of the train along the track. Power is passed to the storage car for storage and distribution of the energy. The storage car utilizes one or more batteries. The storage car permits for one or more outlet boxes or detachable battery packs to allow for operators around the storage car to access the stored energy.

### BACKGROUND

1. Field of the Invention

The present application relates generally to trains and, more particularly, to a power generation and distribution system on a train car.

2. Description of Related Art

Locomotives have been used for many years as a means of transporting people and cargo. Cargo may include various pieces of construction equipment or other working tools. Trains are often used to transport the construction equipment to vicinities near a construction site or operations site. Sources of power at these sites are often produced through diesel generators where the typical electric power grid is unavailable. Power is used to operate lights, power equipment, run heating/cooling units and other such items. Each diesel generator burns fuel and in turn generates pollution (noise and air). Ideas to use battery operated equipment is hindered by the limitation that infrastructure for recharging facilities is very costly and that such sites are typically temporary and cannot justify the expense. Additionally, the ability to recharge the sheer volume of any batteries without generators becomes unrealistic.

A more environmentally sustainable and portable power generation system is needed. Considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a power generating train car in a clean power generation and distribution system according to the preferred embodiment of the present application;

FIG. 2 is a perspective view of an alternative embodiment of the power generating train car of FIG. 1;

FIG. 3 is a perspective view of a power storage train car in the clean power generation and distribution system according the preferred embodiment of the present application; and

FIG. 4 is a perspective view of an alternative embodiment of the power storage train car of FIG. 3.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

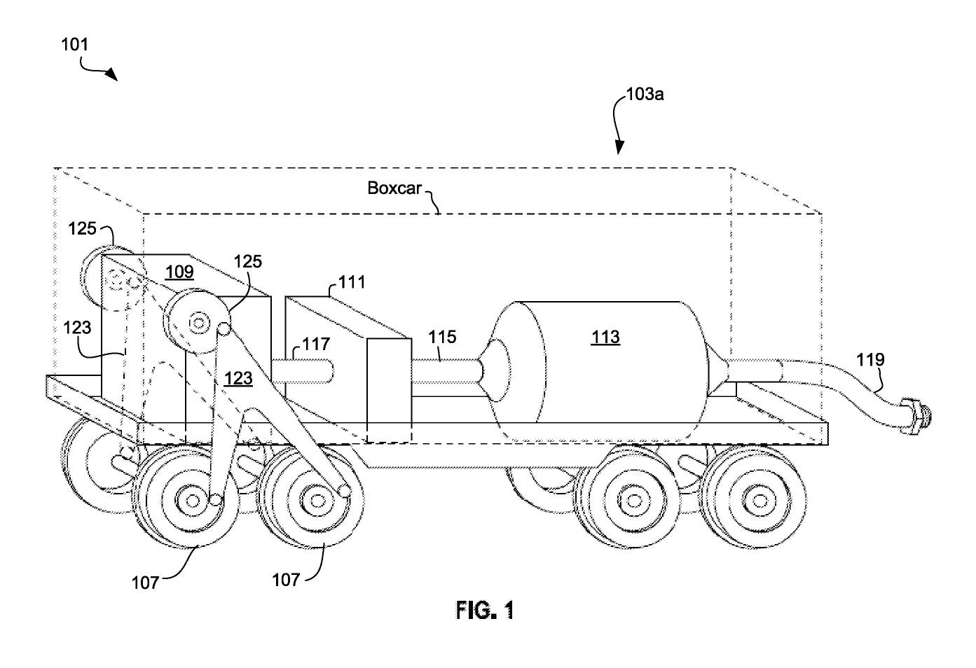

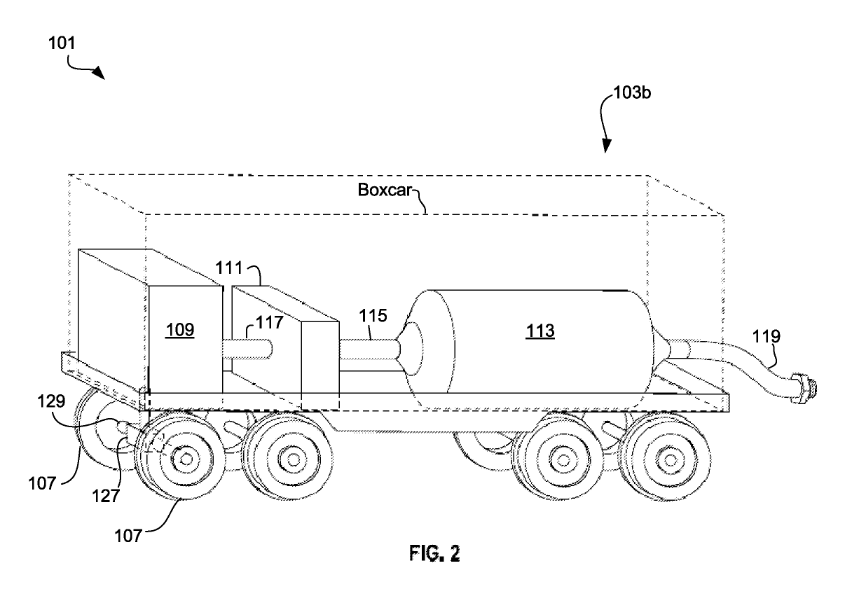

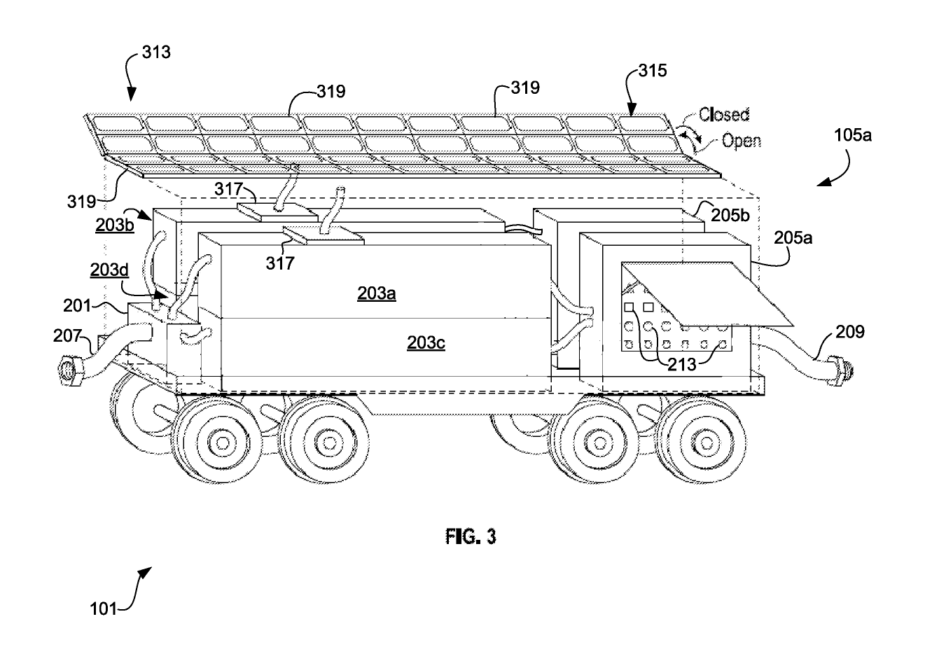

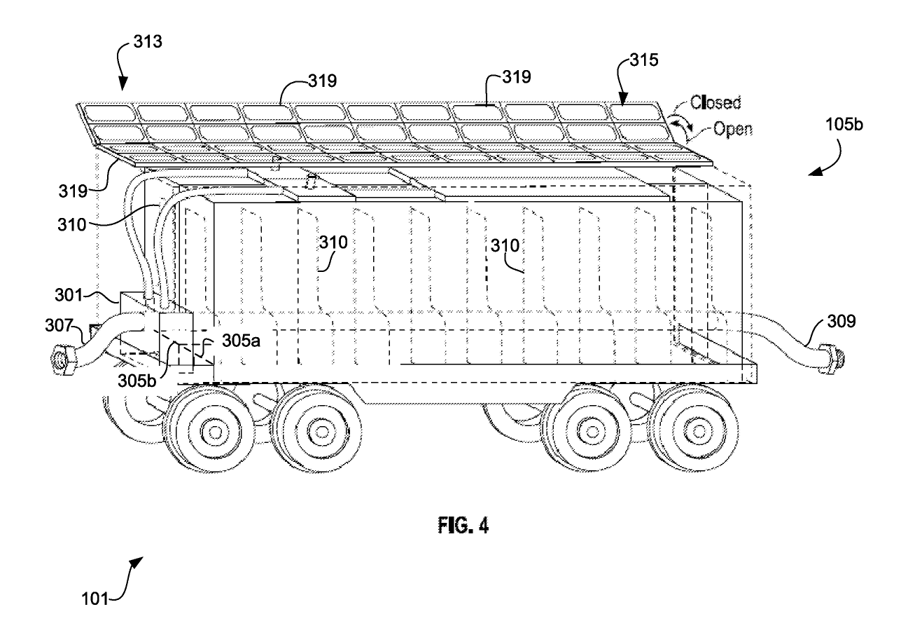

Referring now to FIGS. 1-4 in the drawings, a clean power generation and distribution system 101 is illustrated. System 101 is composed of a charging car and a storage car. FIGS. 1 and 2 illustrate two types of charging cars 103a and 103b, while FIGS. 3 and 4 illustrate two types of energy storage cars 105a and 105b. System 101 generally consists of mounting a geared system to wheel of a train into a boxcar to turn a generator, and produce electricity to charge large-scale batteries in an adjacent boxcar. Such action is done without use of additional liquid or solid fuels that the train is already using to generate movement along the track, thereby the electricity is generated with virtually no additional carbon footprint.

Within system 101, charging cars 103a, 103b are configured to generate an electrical charge (energy) from the rotational movement of rail car wheels along the train track. The storage cars 105a, 105b are coupled to the charging car and are configured to selectively receive the electrical charge and store the electrical charge in one or more batteries. Each storage car 105a, 105b is configured to selectively release the stored electrical charge to one or more pieces of equipment adjacent to the storage car. System 101 is configured to combine either charging car 103a, 103b with either storage car 105a, 105b. Additionally, more than one charging car may be used with one or more storage cars. System 101 allows for the distribution of power to remote locations all generated from clean energy as a result from the movement of the train.

Charging cars 103a, 103b include the geared system internally located within each boxcar and coupled directly to the wheels 107 as seen in FIG. 1; or coupled to the axle in communication with the wheels 107 as seen in FIG. 2. Both charging cars 103a and 103b include similar components of the geared system. For example, the geared system for each includes two gearboxes 109, 111; a generator 113; and a plurality of drive shafts, namely a high-speed shaft 115 and a low-speed shaft 117. The rotational movement of the wheels are transferred through the gearboxes 109, 111 which cause the rotation of shafts 115, 117 at different speeds so as to generate power within the generator 113. The electrical charge is passed through cable 119 to storage cars 105a, 105b for storage and distribution. It is understood that the geared system is representative only and is not limited to the precise numbers or configuration illustrated. Other embodiments may include more or less gearboxes, shafts, and generators depending on design constraints and preference.

As seen in particular with FIG. 1, charging car 103a includes a connecting arm 123 extending between wheel 107 and a disk 125 in direct communication with gearbox 109. Connection arm 123 is pivotally coupled to an exterior of wheels 107 and disk 125, such that one revolution of wheel 107 will produce one revolution of disk 125. In operation, as wheel 107 rotates while the train is in motion, connecting arm 123 rotates disk 125. Gearbox 109 is configured to receive this rotational motion and in turn power the remaining portions of the geared system to generate the electrical charge.

As seen in particular with FIG. 2, charging car 103b further includes an additional gearbox 127. Gearbox 127 is coupled to axle 129 extending between two opposing wheels 107. As wheels 107 rotate, axle 129 rotates gears within gearbox 127. Gearbox 127 transfers the rotational movement of the wheels 107 to gearbox 109 and the other portions of the geared system to generate the electrical charge. FIGS. 1 and 2 have illustrated how rotational movement of the wheels of each particular charging car 103a, 103b may be used to produce electrical power. It is understood that other embodiments may use wheels from other boxcars to assist in powering the geared system within a charging car 103a or 103b. It is also understood that one or more charging cars 103a, 103b may be used within a single train.

Referring now in particular to FIGS. 3 and 4 in the drawings. As stated previously, storage cars 105a, 105b are configured to receive the electrical charge/energy from one or more of charging cars 103a, 103b and route the electrical charge to one or more batteries for storage. As seen in particular with storage car 105a in FIG. 3, car 105a includes a converter box 201, one or more batteries 203a,b,c,d, and an outlet box 205a, 205b. Cars 103a,b and cars 105a, 105b are mechanically linked to follow one from the other as well as being electrically linked through cable 119 and cable 207. Cable 207 mates with cable 119 to produce a continuous path for the electrical charge. Electrical charge is transferred through cable 207 to converter box 201. Converter box 201 is configured to regulate and route electrical charge between one or more charging cars 103a, 103b and one or more storage cars 105a, 105b. Additionally, converter box 201 is configured to regulate and route the amount of electrical charge to one or more batteries. Cable 209 is seen on the opposing end of car 105a as cable 207. Cable 209 is used to electrically couple a second storage car 105a, 105b to that of car 105a. In operation it is understood that system 101 is configured to selectively pass electrical charge through to a second storage car. This may be done automatically through converter box 201 or other control center; or the passing of electrical charge may be handled manually by an operator. For example, if two storage cars are used, the second storage car may be selected to receive electrical charge only once the first storage car is fully charged.

Outlet box 205a is configured to receive power from batteries 203a and 203c. Outlet box 205b is configured to receive power from batteries 203b and 203d. It is understood that such routing of power from the batteries is not limited to that show in FIG. 3. Outlet box 205a, 205b is mounted within the boxcar so as to open outward or externally so as to be accessible by workers outside the boxcar. A retractable door 211 selectively covers and protects one or more outlets 213. Outlets 213 are configured to be an attachment location to receive a plug from one or more different types of equipment. Different types of outlets are incorporated within outlet box 205a,205b to fit different styled plugs and electrical demands. By attaching a plug to the outlet 213, equipment is configured to receive power from one or more batteries.

With respect to FIG. 4, storage car 105b is similar in form and function to that of storage car 105a in FIG. 3. Storage car 105b includes a converter box 301 similar to that of converter box 201. Electrical charge is passed through cable 307 and alternatively cable 309 when a second storage car is used. A difference in storage car 105b not seen in storage car 105a is that storage car 105b includes one or more battery charging docks 305a, 305b. Charging docks 305a, 305b are used to individually house one or more portable and detachable batteries or battery packs 310. Converter box 301 selectively routes and regulates power delivery to and through each charging dock and finally to each battery pack.

Each battery pack 310 is configured to be removable from the respective charging dock. In operation, an operator may remove the battery pack and transport it to a remote location for use. When a recharging is needed, the battery pack may be returned and swapped out for another battery pack. The portable nature of each battery allows this configuration to supply power to more remote locations than the system of storage car 105a seen in FIG. 3. The power in each battery pack 310 may be sufficient to power small tools to large flood lights for example. Each battery pack 310 reduces the need for separate and individual gas/diesel powered generators. The battery packs and batteries of each storage car 105a, 105b provide clean and safe energy.

Each storage car 105a, 105b is detachable from the charging car and respective train, thereby permitting a user to drop off and leave one or more charging cars at respective sites or locations as needed. When charging is required, each storage car may be reattached to a respective charging car and train and transported to recharge. In its stead, another storage car may be left to provide a continuous supply of energy at the location.

In an alternative embodiment, each storage car 105a, 105b may be optionally equipped with a power collection system configured to charge the one or more batteries when the storage car is stationary. An example of a power collection system 313 may be a solar power system 315. Such a system 315 is illustrated in both FIGS. 3 and 4. Deployable solar panels 319 are coupled to the storage car and transfer power through a solar panel converters 317 integrated within the electrical routing of each storage car to permit for the routing of electrical charge to the batteries. Solar panels 319 are configured to deploy between an open and close position, where the panels fold over on each other. Only half of solar power system 315 is illustrated in FIGS. 3 and 4 in order to provide a view of converters 317 and batteries 321 to operate the solar power system 315 between open and closed positions. Deployment may be done automatically upon the detection of a loss of electrical power; or manually by an operator. For example, solar power system 315 may automatically open for charging to compensate for the self-discharge rate of the batteries, when the batteries are detected as having a low charge. It is understood that solar power system 315 may selectively operate simultaneously with charging cars when the storage car is in motion along the track, although this is not the preferred method of operation.

In operation, fully charged train cars (storage cars) could be offloaded and shipped anywhere additional electricity is needed. Construction companies could replace diesel generators with fully charged boxcars. When the storage cars are drained, each may be replaced with fully charged storage cars. The drained storage cars could then be loaded onto the train for recharging. Electricity could be provided to countless number of industries with no additional carbon footprint than is already being created by the trains. If new construction vehicles were constructed to operate off of battery packs, each storage car would be sufficient to supply the power required to operate the vehicle.

The current application has many advantages over the prior art including at least the following: (1) reduced carbon footprint; (2) portable power supplies housed in a boxcar; (3) detachable and portable battery packs; (4) ability to charge and recharge during transportation and while stationary without the use of diesel generators.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A clean power generation and distribution system for a train, comprising:
a charging car configured to generate an electrical charge from the movement of the train along a track; and
a storage car coupled to the charging car, the storage car configured to receive the electrical charge from the charging car, the storage car having one or more batteries to store the electrical charge, the storage car configured to selectively release the stored electrical charge;
wherein the charging car and the storage car are transportable along the track.

2. The system of claim 1, further comprising:
a gearbox configured to transfer the rotational movement of charging car wheels to a generator for the production of the electrical charge, the charging car wheels running along the track.

3. The system of claim 2, wherein the gearbox is coupled to the axle of the charging car.

4. The system of claim 2, wherein the gearbox is coupled to the wheels of the charging car.

5. The system of claim 1, wherein the batteries are removable from the storage car and configured to supply power remote from the storage car.

6. The system of claim 1, wherein the charging car may be coupled to a second storage car.

7. The system of claim 6, wherein the storage car is configured to selectively pass electrical charge through to a second storage car.

8. The system of claim 6, wherein an operator may selectively route the electrical charge of the charging car between storage cars.

9. The system of claim 1, wherein the charging car and storage car are configured to be detached from one another.

10. The system of claim 1, further comprising:
an outlet box configured to have one or more outlets, the outlets being an attachment location on the storage car to drain the electrical charge from the one or more batteries.

11. The system of claim 10, wherein the outlets are accessible from the exterior of the storage car.

12. The system of claim 1, wherein the one or more batteries are detachable from a docking station within the storage car.

13. The system of claim 1, further comprising:
a power collection system configured to charge the one or more batteries when the storage car is stationary.

14. The system of claim 13, wherein the power collection system is a solar power system.

15. The system of claim 14, wherein the solar power system has one or more solar panels configured to be selectively deployed.

16. A method of providing power to a site, comprising:
charging a storage car containing one or more batteries with a portion of stored energy;
locating the storage car at the site; and
selectively dispersing power from the one or more batteries.

17. The method of claim 16, further comprising:
coupling a charging car to the storage car.

18. The method of claim 16, further comprising:
distributing the one or more batteries remote from the storage car, the one or more batteries being detachable from the storage car.

19. The method of claim 16, further comprising:
attaching one or more plugs to an outlet box on the storage car for selectively dispersing energy from the one or more batteries.

20. The method of claim 16, wherein charging is done by at least one of a solar power collection system and power generated from the rotational energy of a wheel generated during transportation of a train.
